(19) United States
(12) Patent Application Publication
(10) Pub. No.: US 2025/0250145 A1
(43) Pub. Date: Aug. 7, 2025

(54) ASSEMBLY LIFT FIXTURE

(71) Applicant: Applied Materials, Inc., Santa Clara, CA (US)

(72) Inventors: Anilkumar Borkar, Bangalore (IN); Prathap Ramappa, Hosur (IN); Shivaprasad Kota, Bangalore (IN)

(21) Appl. No.: 19/029,621

(22) Filed: Jan. 17, 2025

Related U.S. Application Data
(60) Provisional application No. 63/550,558, filed on Feb. 6, 2024.

(51) Int. Cl. B66C 1/66

(52) U.S. Cl. CPC B66C 1/66

(57) ABSTRACT

An assembly lift fixture includes a body component, a hoist connector, and a pin structure. The body component includes an upper flange forming an upper opening and a bottom portion forming a recess configured to receive a protrusion of an assembly. The hoist connector is secured to the upper flange via a first fastener partially passing through the upper opening. The pin structure is configured to pass through the bottom portion of the body component and the protrusion of the assembly to secure the assembly to the assembly lift fixture.

### RELATED APPLICATION

This application claims benefit of U.S. Provisional Application No. 63/550,558, filed Feb. 6, 2024, the contents of which are incorporated by reference herein in their entirety.

### TECHNICAL FIELD

Embodiments of the present disclosure relate to lift fixtures, such as those used in association with substrate processing systems, and in particular to an assembly lift fixture.

### BACKGROUND

In substrate processing and other electronics processing, processing chambers are used to perform substrate processing operations. Different components are inserted into the processing chambers to perform substrate processing operations and are removed from the processing chambers to perform maintenance and/or replacement of the components.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, an assembly lift fixture includes: a body component including an upper flange forming an upper opening and a bottom portion forming a recess configured to receive a protrusion of an assembly; a hoist connector secured to the upper flange via a first fastener partially passing through the upper opening; and a pin structure configured to pass through the bottom portion of the body component and the protrusion of the assembly to secure the assembly to the assembly lift fixture.

In another aspect of the disclosure, an assembly lift fixture includes: a hoist connector including a disc-shaped upper portion configured to enter a disc-shaped chamber formed by a hoist and a cylindrical neck portion configured to pass through a slot formed by the hoist; and a body component including an upper portion coupled to the hoist connector and a bottom portion configured to removably connect to an assembly. The hoist is to move the assembly responsive to the hoist connector being coupled to the hoist and the bottom portion of the body component removably connecting to the assembly.

In another aspect of the disclosure, an assembly lift fixture includes: a hoist connector portion configured to couple to a hoist; a bottom portion forming a recess configured to receive a protrusion of an assembly; a sleeve configured to insert into a first sidewall of the bottom portion and pass through the protrusion of the assembly; and a pin configured to pass through the first sidewall of the bottom portion, the sleeve, and a second sidewall of the bottom portion to secure the sleeve to the bottom portion.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A illustrates a system including an assembly lift fixture, according to certain embodiments.

FIG. 1B illustrates an upper schematic view of a digital photolithography system, according to certain embodiments.

FIGS. 2A-B illustrates hoists and assembly lift fixtures, according to certain embodiments.

FIGS. 3A-M illustrate assembly lift fixtures, according to certain embodiments.

### DETAILED DESCRIPTION OF EMBODIMENTS

Embodiments described herein are related to assembly lift fixtures (e.g., substrate processing assembly lift fixture).

In substrate processing and other electronics processing, processing chambers are used to perform substrate processing operations. Different components are inserted into the processing chambers to perform substrate processing operations and are removed from the processing chambers to perform maintenance and/or replacement of the components.

Conventionally, a corresponding fixture is permanently attached to each component of a processing chamber. The fixture is used for installing the component in the processing chamber and removing the component from the processing chamber (e.g., for repair, for maintenance, for replacement, etc.). If there are forty components in a processing chamber, conventionally forty fixtures are permanently attached, one fixture for each component. Each fixture takes up space, adds additional materials, and takes additional time for installation, commissioning, and repair.

The components, assemblies, systems, and methods disclosed herein provide solutions to these and other problems of conventional systems. The assembly lift fixture of the present disclosure is configured to removably attach to an assembly of a processing chamber.

An assembly lift fixture includes a body component, a hoist connector, and a pin structure. The body component includes an upper flange forming an upper opening. The body component further includes a bottom portion forming a recess configured to receive a protrusion of an assembly (e.g., laser component of the processing chamber).

The hoist connector is secured to the upper flange via a first fastener partially passing through the upper opening. In some embodiments, the hoist connector comprises a disc-shaped upper portion and a cylindrical neck portion.

In some embodiments, the assembly lift fixture includes a second fastener that rotatably interfaces with the bottom portion to adjust size of the recess formed by the bottom portion. In some embodiments, the assembly lift fixture further includes a third fastener configured to secure the second fastener in the bottom portion (e.g., prevent the second fastener from falling out of the bottom portion).

The pin structure is configured to pass through the bottom portion of the body component and the protrusion of the assembly to secure the assembly to the assembly lift fixture.

In some embodiments, the pin structure includes a sleeve and a pin. In some embodiments, the sleeve is secured around the pin via friction fit. In some embodiments, a distal portion of the pin comprises a spring-loaded component configured to protrude from the pin responsive to passing through the bottom portion of the body component.

In some embodiments, the assembly lift fixture further includes a lanyard including a first distal end and a second distal end, the first distal end being secured to the body component, the second distal end being configured to secure to the pin structure.

The components, systems, and methods disclosed herein have advantages over conventional solutions. The assembly lift fixture of the present disclosure is configured to removably attach to an assembly of a processing chamber. Instead of having one fixture per assembly like in conventional systems, the present disclosure allows provides an assembly lift fixture that can be removably attached to any of the assemblies for installing or removal of the assembly. This allows the present disclosure to take up less space, have less materials, and take less time for installation, commissioning, and repair.

Although some embodiments of the present disclosure are described with relation to assembly lift devices used to install and remove a substrate processing assembly, in some embodiments, the assembly lift device can be used to install and/or remove other types of assemblies and/or components.

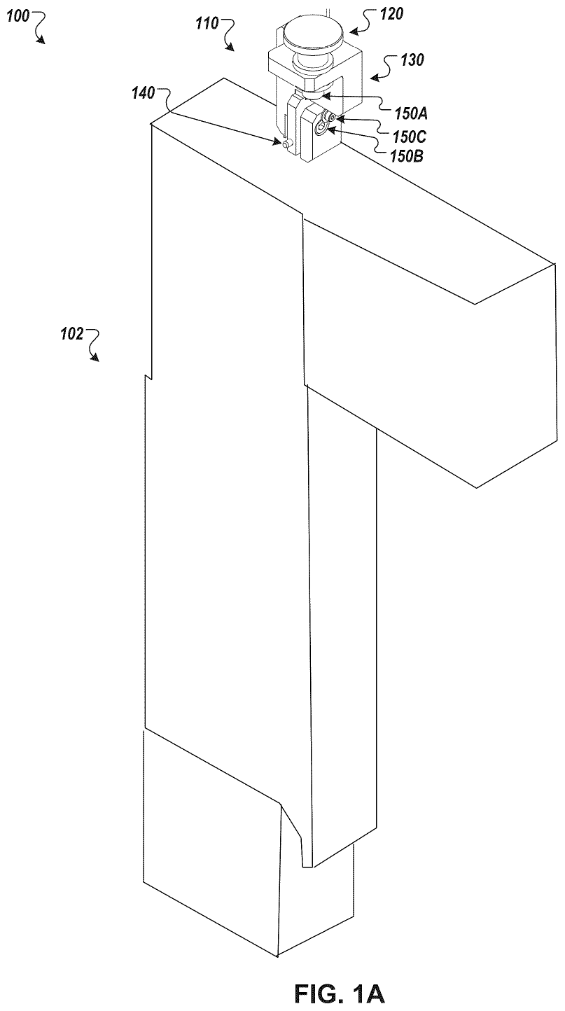

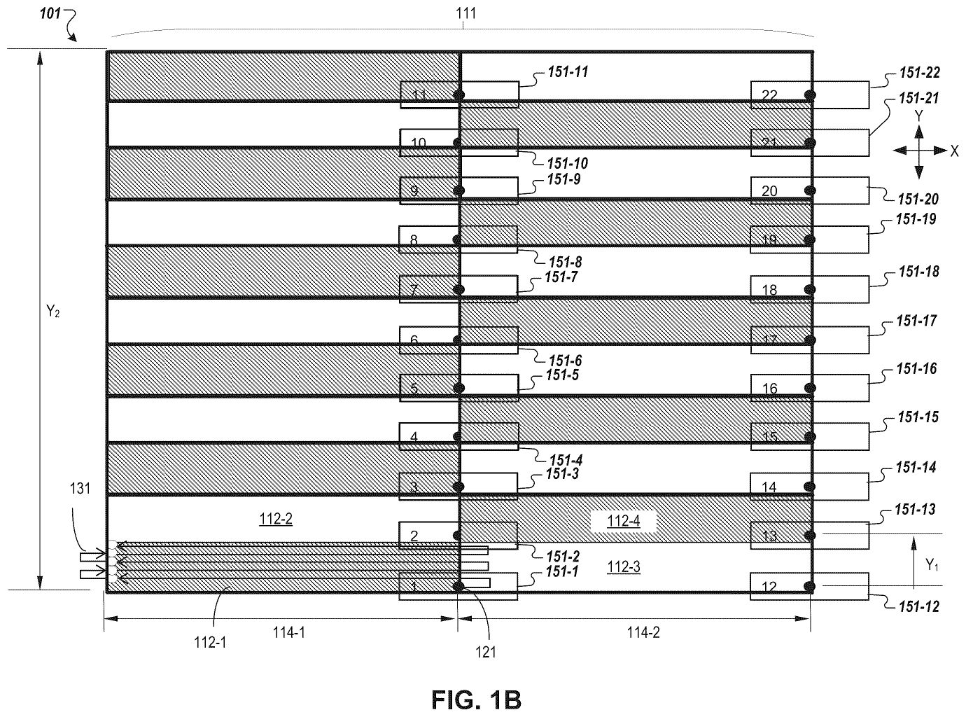

FIG. 1A illustrates a system 100 including an assembly lift fixture 110, according to certain embodiments.

An assembly lift fixture 110 removably attaches to an assembly 102. In some embodiments, the assembly 102 is a laser component of the processing chamber. In some embodiments, the assembly 102 is an exposure unit (e.g., digital lithography exposure unit). In some embodiments, the assembly 102 is an EYE exposure unit. In some embodiments, the assembly 102 is an optical imaging unit. In some embodiments, the assembly 102 is a module. In some embodiments, the assembly 102 is paneling.

The assembly 102 includes a protrusion. The assembly 102 may include a base plate that includes the protrusion.

The assembly lift fixture 110 includes a hoist connector 120, a body component 130, a pin structure 140, and fasteners 150A-C.

In some embodiments, the body component 130 includes an upper flange forming an upper opening and a bottom portion forming a recess configured to receive a protrusion of the assembly 102.

In some embodiments, the hoist connector 120 is secured to the upper flange of the body component 130 via a fastener 150A partially passing through the upper opening.

In some embodiments, the pin structure 140 is configured to pass through the bottom portion of the body component 130 and the protrusion of the assembly 102 to secure the assembly 102 to the assembly lift fixture 110.

In some embodiments, the fastener 150B is configured to rotatably interface with the bottom portion of the body component 130 to adjust size of the recess formed by the bottom portion. In some embodiments, the fastener 150C is configured to secure the fastener 150B in the bottom portion of the body component 130.

FIG. 1B illustrates an upper view of a digital photolithography system (“system”) 101, according to certain embodiments. System 101 includes one or more exposure units 151 (e.g., EYE, assembly 102 of FIG. 1A).

As shown, the system 101 includes a stage assembly 111 including a base (e.g., a granite base), a stage and a substrate disposed on the stage. The substrate may be a glass plate, a wafer, a printed circuit board (PCB), or other type of substrate. The substrate may correspond to or be positioned in a digital lithography printing or scanning area having a number of scan regions, including scan regions 112-1 through 112-4. The left portion of the stage assembly 111 corresponds to a first bridge 114-1 above the stage assembly 111 and the right portion of the stage assembly 111 corresponds to a second bridge 114-2 above the stage assembly 111. Exposure units are attached to the bridges 114-1 and 114-2. In some embodiments, the length of each bridge 114-1 and 114-2 can range between about 500 millimeters (mm) and about 1000 mm. For example, the length of each bridge 114-1 and 114-2 can be about 750 mm.

The substrate can include a photoresist material disposed on a material to be etched. The photoresist material can be a positive photoresist material (i.e., where a portion of the photoresist material that is exposed to light becomes soluble to a photoresist developer) or a negative photoresist material (i.e., where a portion of the photoresist material that is exposed to light becomes insoluble to a photoresist developer). By removing designated portions of the photoresist material, a photoresist pattern can be formed. In some embodiments, the material to be etched is a conductive material (e.g., metal). For example, the conductive material can be molybdenum. After the designated regions of the photoresist material are removed, the now-exposed material can be etched in accordance with the photoresist pattern. For example, wiring can be formed during the etch process. Alternatively, the patterned material can itself be photosensitive, eliminating the need to add a photoresist layer and performing the following etch process.

To perform the photoresist patterning, the system 101 further includes a first column of digital lithography exposure units 151 (“exposure units”) hanging from the first bridge 114-1 and a second column of exposure units 151 hanging from the second bridge 114-2. For example, the first column of exposure units 151 includes exposure units 151-1 through 151-11 and the second column of exposure units includes exposure units 151-12 through 151-22. Thus, in this illustrative example, there are 22 total exposure units 151 shown. However, the number of exposure units shown in FIG. 1B should not be considered limiting, and the system 101 can include any suitable number of exposure units 151.

Each exposure unit 151 can include a lens assembly 121 that can project an image onto the photoresist material of the substrate. Each lens assembly 121 is shown adjacent to a bottom-right corner of its associated scan region. For example, a lens assembly 121 of exposure unit 151-1 is associated with the scan region 112-1. In some embodiments, each lens assembly 121 is about 4 mm tall and about 3 mm wide. However, each lens assembly 121 can have any suitable dimensions.

During a digital lithography process, each exposure unit 151 is moved relative to the substrate to expose a region (e.g., a rectangular region) of the substrate to electromagnetic radiation such as light (e.g., ultraviolet light, near-ultraviolet light, etc.). This may include moving the exposure units 151 and/or moving the substrate. During scanning, the exposure units 151 expose respective scan regions, in accordance with a programmed scan path. Instead of having the exposure units move above the stage assembly 111, the stage assembly 111 can move in the X-Y direction underneath the exposure units 151 in accordance with the programmed scan path. Since the field-of-view of a lens assembly (e.g., lens assembly 121) can be smaller than its associated scan region (e.g., scan region 112-1), the stage assembly 111 may have to move back and forth repeatedly until the entire scan region (e.g., scan region 112-1) is printed. The lens assembly 121 is projected to scan the scan region 112-1, except for the first and last scans where trimming may occur based on the definition of the scan region 112-1. The greater the number of exposure units 151, the fewer scans that may be performed, which can correspond to higher throughput.

Each exposure unit 151 can be responsible for a different scan region, which may or may not overlap with the adjacent scan regions of other exposure units 151. To avoid abrupt transitions from a first scan region to a second scan region adjacent to the first scan region (either attached to the same bridge or to a different bridge), the exposure unit 151 corresponding to the first scan region can encroach into the second scan region. Similarly, the exposure unit 151 corresponding to the second scan region can encroach into the first scan region. For example, exposure unit 151-1 can encroach into scan region 112-2 and/or scan region 112-3, and exposure unit 151-2 can encroach into scan region 112-1 and/or scan region 112-4.

In an example, a path 131 of the exposure unit 151-1 (e.g., lens assembly 121-1) is illustratively depicted. The path 131 proceeds in a snake-like fashion. More specifically, during scanning, the stage assembly 111 moves in the X direction (i.e., from right to left) across the scan region 112-1, during which time the exposure unit 151-1 patterns a line across the scan region 112-1. The stage assembly 111, upon reaching the left edge of the scan region 112-1, moves in the Y-direction (i.e., up), and then moves in the X-direction (i.e., from left to right) to pattern another line across the scan region 112-1. The path 131 proceeds in this snake-like fashion until reaching the opposite end of the scan region 112-1, at which point a full image has been patterned on the substrate. The image can then be developed for substrate etching. The distance of stage travel in the Y-direction during scanning, “Y₁”, can be any suitable distance. In some embodiments, Y₁ can range between about 151 mm and about 180 mm. For example, Y₁ can be about 164 mm. The scan distance in the X direction for each exposure unit corresponds to the length of the bridges 114-1 and 114-2 in embodiments. The total width of the scan regions, “Y₂”, can be any suitable width. In some embodiments, “Y₂” can range between about 1600 mm and about 2000 mm. For example, Y₂ can be about 1800 mm. The travel distance for each scan (e.g., in the X-direction) can be different due to differences in substrate size. For example, in some embodiments, the substrate includes an 8-inch round wafer. As another example, in some embodiments, the substrate includes a 12-inch round wafer.

The scanning process shown in FIG. 1B can be used to create a display (e.g., a flat panel display) in embodiments. In some embodiments, the display is a liquid-crystal display (LCD).

In some embodiments, system 101 includes one or more exposure units 151 (i.e., EYEs, one or more of exposure units 151-1 to 151-22). In some embodiments, system 101 includes a movable platform that sits beneath the exposure units 151 that moves in the x-y-z direction (relative to the one or more exposure units 151). In some embodiments, system 101 includes one or more a movable support (i.e., a rotation assembly) to which one or more of the exposure units 151 are attached that adjusts the angle of the exposure units 151 relative to the platform (where rotation is about a z axis). In some embodiments, the system 101 is configured to rotate the exposure unit 151 (e.g., EYE) so that an angle of a mirror array of the exposure unit 151 (e.g., EYE) matches an angle of the platform. In some embodiments, each exposure unit 151 (e.g., EYE) has its own rotation device, and the rotations of the exposure units 151 (e.g., EYEs) are matched so that instead of having a different patterning set of parameters for each of the exposure units 151 (e.g., EYEs), the exposure units 151 (e.g., EYEs) all share the same set of parameters.

The one or more exposure units 151 may be a digital micro-mirror device (DMD) configured to focus patterned light onto a substrate (e.g., pixel-by-pixel).

In some embodiments, system 101 includes an assembly lift fixture (e.g., assembly lift fixture 110 of FIG. 1A) that removably attaches to an exposure unit 151 to move the exposure unit 151 (e.g., for installation, removal, maintenance, etc.). In some embodiments, the assembly lift fixture forms a recess configured to receive a protrusion (e.g., protrusion of a backing plate) of exposure unit 151 and assembly lift fixture includes a pin structure that is configured to pass through a bottom portion of the assembly lift fixture and the protrusion of the exposure unit 151 to secure the exposure unit 151 to the assembly lift fixture.

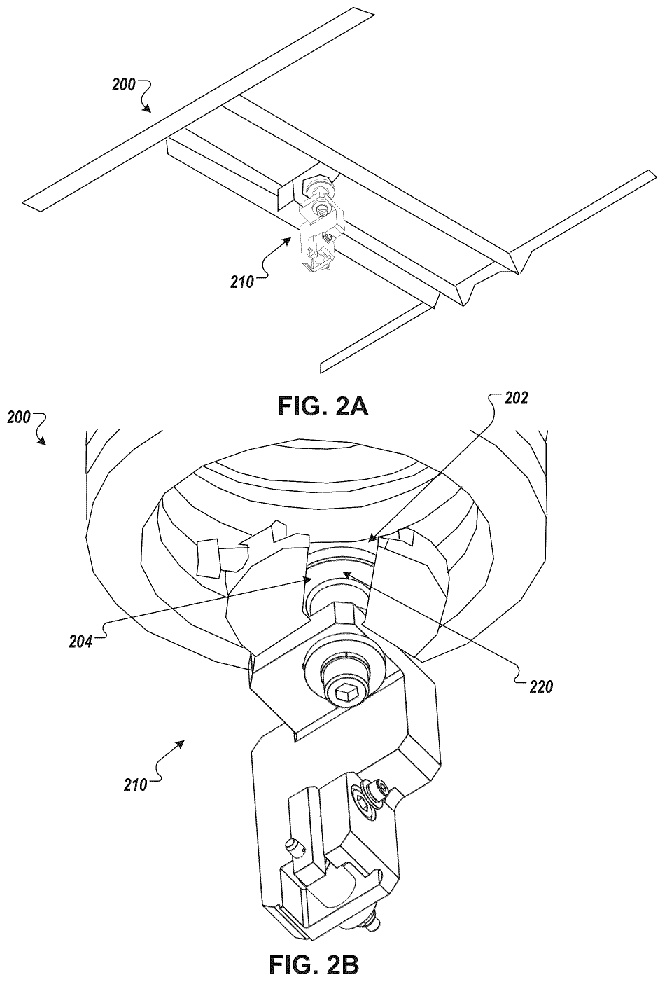

FIGS. 2A-B illustrates hoists 200 (e.g., cranes) and assembly lift fixtures 210 (e.g., assembly lift fixture 110 of FIG. 1A), according to certain embodiments. The hoist 200 may be configured to secure (e.g., removably secure) an assembly lift fixture 210 and move the assembly lift fixture 210 in one or more of the x-direction, the y-direction, and/or the z-direction. The assembly lift fixture 210 may be removably securing an assembly (e.g., exposure unit). The hoist 200 may move the assembly lift fixture 210 which moves the assembly (e.g., exposure unit) for installation, replacement, removal, maintenance, etc. of the assembly.

The assembly lift fixture 210 may include a hoist connector 220 (e.g., hoist connector 120 of FIG. 1A) that is configured to couple (e.g., permanently attached, removably attached) to the hoist 200. The hoist connector 220 may include a disc-shaped upper portion configured to enter a disc-shaped chamber 202 of the hoist 200. The hoist connector 220 may further include a cylindrical neck portion that is configured to pass through a slot 204 formed by the hoist 200.

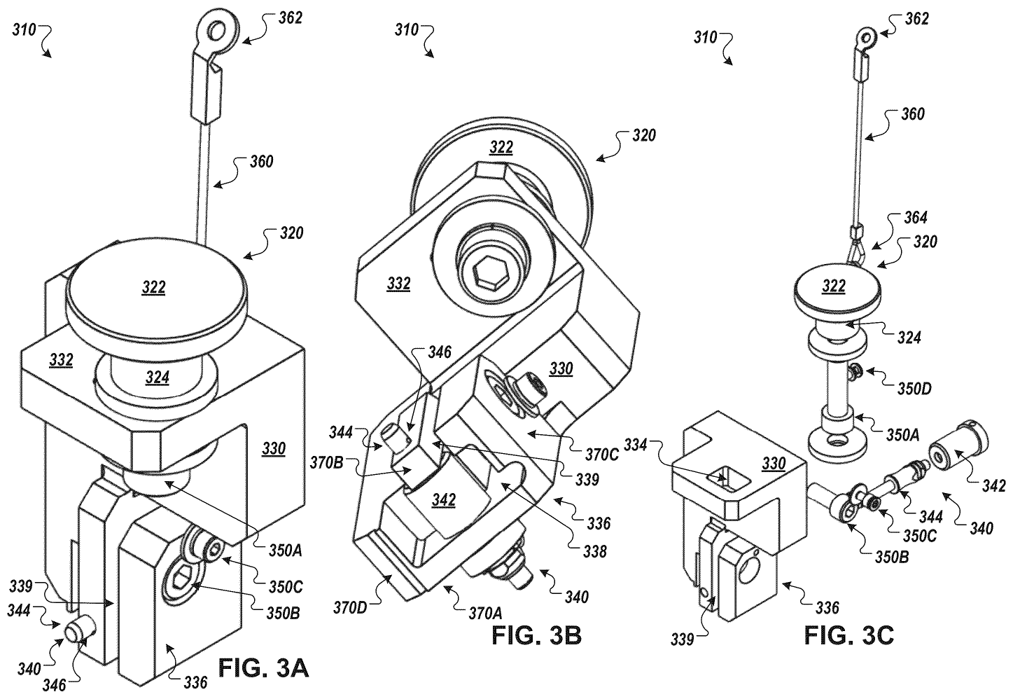

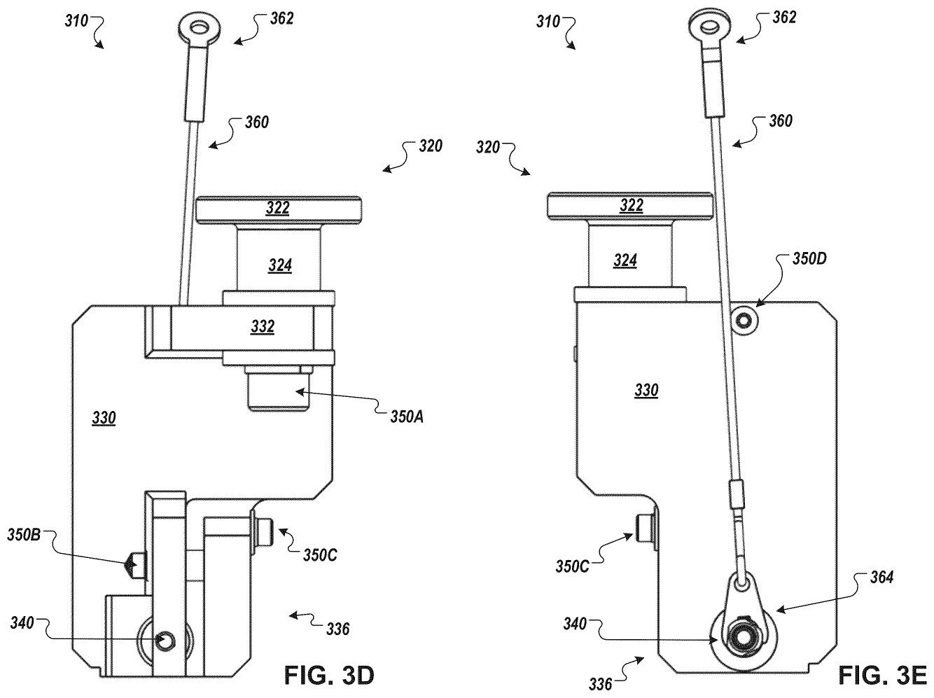

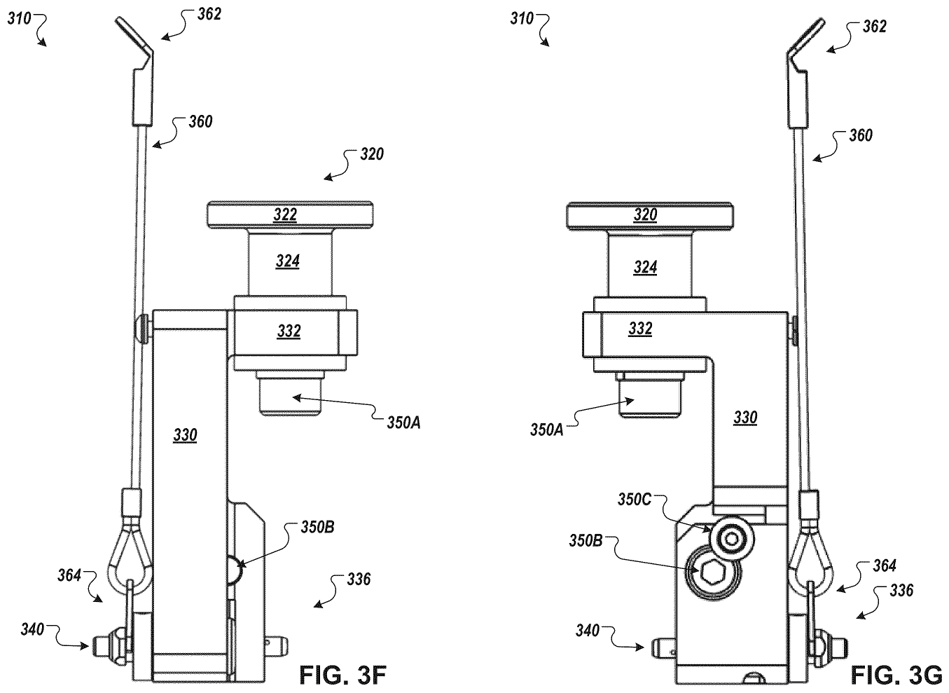

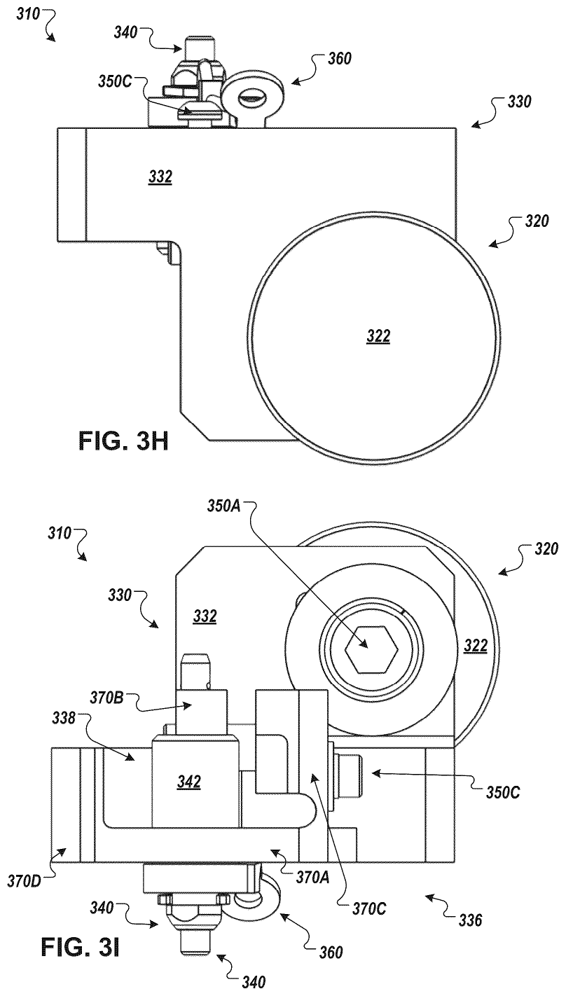

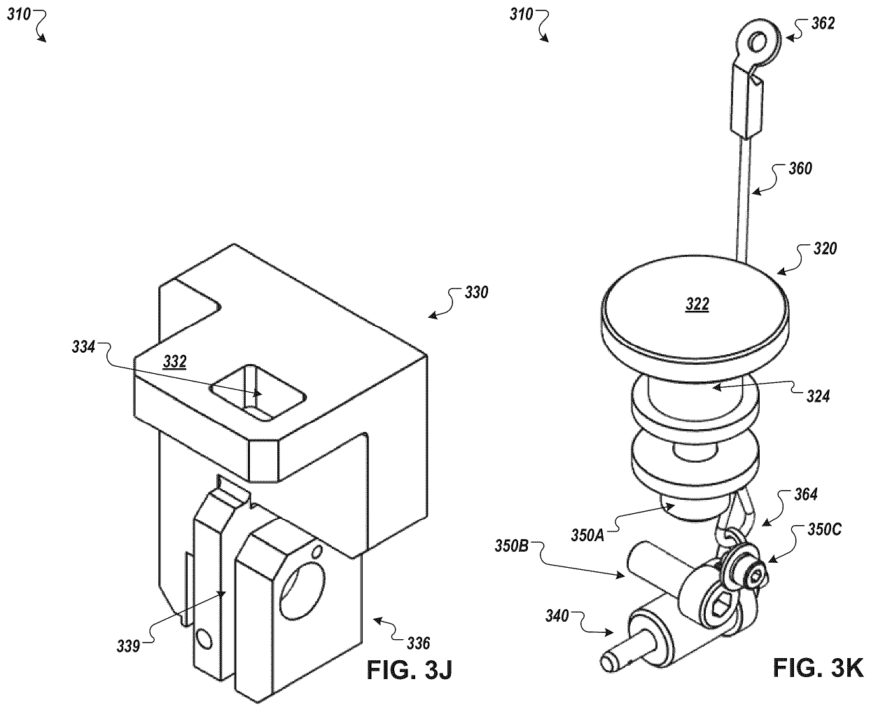

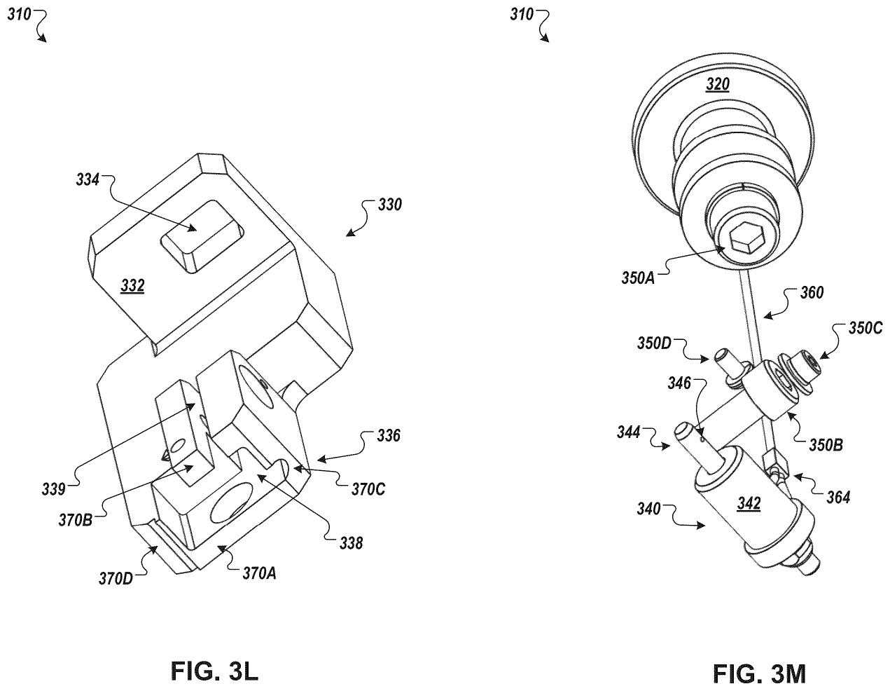

FIGS. 3A-M illustrate assembly lift fixtures 310 (e.g., assembly lift fixture 110 of FIG. 1A, assembly lift fixture 210 of FIGS. 2A and/or 2B), according to certain embodiments.

FIG. 3A is an upper perspective view, FIG. 3B is a lower perspective view, FIG. 3C is an exploded view, FIG. 3D is a front view, FIG. 3E is a rear view, FIG. 3F is a first side view, FIG. 3G is a second side view, FIG. 3H is an upper view, FIG. 3I is a lower view, FIG. 3J is an upper perspective view of a body component 330 of the assembly lift fixture 310, FIG. 3K is an upper perspective view of components of the assembly lift fixture 310 (e.g., without the body component 330), FIG. 3L is a bottom perspective view of a body component 330 of the assembly lift fixture 310, FIG. 3K is an upper perspective view of components of the assembly lift fixture 310 (e.g., without the body component 330).

An assembly lift fixture 310 includes a hoist connector 320 (e.g., hoist connector 120 of FIG. 1A, hoist connector 220 of FIG. 2B, etc.), a body component 330 (e.g., body component 130 of FIG. 1A), a pin structure 340 (e.g., pin structure 140 of FIG. 1A), one or more fasteners 350 (e.g., fasteners 150 of FIG. 1A), and/or a lanyard 360.

In some embodiments, the body component 330 includes an upper portion coupled to the hoist connector 320. The body component 330 may include an upper flange 332 (e.g., upper portion) that forms an upper opening 334. In some embodiments, the upper opening 334 is rectangular. In some embodiments, the body component 330 includes a bottom portion 336 that is configured to removably connect to an assembly. The bottom portion 336 may form a recess 338 configured to receive a protrusion of an assembly (e.g., assembly 102 of FIG. 1A, exposure unit 151 of FIG. 1B, etc.). A hoist (e.g., hoist 200 of FIG. 2A and/or FIG. 2B) may move the assembly responsive to the hoist connector 320 being coupled to the hoist and the bottom portion 336 of the body component 330 being removably connected to the assembly.

In some embodiments, the hoist connector 320 (e.g., hoist connector portion) is configured to couple to a hoist. The hoist connector 320 may be secured to the upper flange 332 (e.g., upper portion) of the body component 330 via a fastener 350A partially passing through the upper opening 334. The fastener 350A may include a bolt (or screw), a first washer disposed between the head of the bolt (or screw) and a lower surface of the upper flange 332, and a second washer disposed between an upper surface of the upper flange 332 and the hoist connector 320. The hoist connector 320 may include a disc-shaped upper portion 322 (e.g., mushroom head) and a cylindrical neck portion 324. The disc-shaped upper portion 322 is configured to enter a disc-shaped chamber formed by a hoist (e.g., disc-shaped chamber 202 of hoist 200 of FIG. 2B). The cylindrical neck portion 324 may be configured to pass through a slot formed by the hoist (e.g., slot 204 formed by hoist 200).

A first distal end of the fastener 350A may be a head that is disposed under the upper flange 332 and a second distal end of the fastener 350A may be rotatably inserted into a bottom portion of the cylindrical neck portion 324 of the hoist connector 320.

In some embodiments, the upper opening 334 is a rectangular (e.g., square) opening. In some embodiments, the fastener 350A is to adjustably secure to the hoist connector 320 (e.g., cylindrical neck portion 324) through the upper opening 334 to adjust center of gravity of the assembly lift fixture 310 securing the assembly. The assembly lift fixture 310 may secure an assembly and the fastener 350A may be moved to different locations in the upper opening 334 until the center of gravity of the assembly lift fixture 310 plus the assembly is in a predetermined location (e.g., balanced center of gravity, center of gravity located substantially in the center of the assembly, center of gravity is located in the assembly).

In some embodiments, the pin structure 340 is configured to pass through the bottom portion 336 of the body component 330 and the protrusion of the assembly to secure the assembly to the assembly lift fixture 310. In some embodiments, the pin structure 340 includes a sleeve 342 and a pin 344. The sleeve 342 is secured around the pin 344 via friction fit. The sleeve 342 and the pin 344 pass through the protrusion of the assembly. In some embodiments, the sleeve 342 secures the weight of the assembly and the pin 344 prevents the sleeve 342 from falling out of the bottom portion 336 of the body component 330. In some embodiments, a distal portion of the pin 344 includes one or more spring-loaded components 346 (e.g., compression spring, pressurized roller ball, spring-loaded ball) configured to protrude from the pin 344 responsive to the pin 344 passing through the bottom portion 336 of the body component 330.

In some embodiments, sidewalls 370A-D of bottom portion 336 of body component 330 form the recess 338. In some embodiments, the sleeve 342 is configured to insert into sidewall 370A of the bottom portion 336 of the body component 330 and to pass through the protrusion of the assembly. The pin may be configured to pass through sidewall 370A of the bottom portion 336, the sleeve 342, and sidewall 370B (e.g., opposite sidewall 370A) of the bottom portion 336 to secure the sleeve 342 to the bottom portion 336. In some embodiments, sidewall 370C forms a bore and a counterbore. The fastener 350B includes a body that passes through the bore of sidewall 370C and has a head that is disposed in the counterbore of sidewall 370C. The head of fastener 350B is at a first distal end of fastener 350B. The second distal end fastener 350B may removably secure to sidewall 370B. A gap 339 between sidewall 370C and sidewall 370B (and the recess formed by sidewalls 370A-D) may be larger responsive to the fastener 350B being threaded (e.g., rotatably interfaced) further out of sidewall 370B and may be smaller responsive to the fastener 350B being threaded (e.g., rotatably interfaced) further into sidewall 370B.

In some embodiments, the lanyard 360 includes a first distal end 362 configured to secure to the body component 330 and a second distal end 364 configured to secure to the pin structure 340. The portion of the lanyard 360 between the first distal end and the second distal end 364 may be a flexible cord. The first distal end 362 may form an opening. A fastener 350D may secure the first distal end 362 of the lanyard 360 to the body component 330 by passing partially through the opening formed by the fist distal end 362. In some embodiments, the second distal end 364 is shaped to form a friction fit on the pin 344 of the pin structure 340 (e.g., second distal end 364 is secured to the pin 344 may be pressed against the pin 344). In some embodiments, the second distal end 364 forms an opening and the pin 344 passes through the opening formed by the second distal end 364 of lanyard 360.

In some embodiments, fastener 350B (e.g., adjustment fastener) is configured to rotatably interface with the bottom portion 336 of the body component 330 to adjust size of the recess 368 formed by the bottom portion 336. The fastener 350B may be screwed into or screwed out of the bottom portion 336 to cause a sidewall of the bottom portion to form a smaller or larger recess (e.g., to substantially match the size of the protrusion of the assembly). The bottom portion 336 of the body component 330 may form a gap 339 (e.g., slit) and the tightening of the fastener 350B may make the gap 339 smaller and the loosening of the fastener 350B may make the gap 339 larger.

In some embodiments, a fastener 350C (e.g., securing fastener) is configured to secure the fastener 350B in the bottom portion 336. The fastener 330B may be a bolt or a screw, where the head of the fastener 330B is embedded in the bottom portion 336 (e.g., the head is in a counterbore formed by the bottom portion 336) so that the head does not protrude from the bottom portion 336. The fastener 350C may include a bolt or a screw and a washer. The head of the fastener 350C (e.g., bolt or screw) and/or the washer may overlap a portion of the head of the fastener 350B so that the fastener 350B cannot fall out of the bottom portion 336 even when the fastener 350B is completely loosened (e.g., the threads of the body of the fastener 350B are not engaging with the bottom portion 336).

In some embodiments, assembly lift fixture 310 is an EYE lifting fixture. Conventional EYE lifting fixtures are permanently fixed to EYE modules (e.g., dedicated EYE lifting fixture for each EYE) which is very costly, includes more commissioning, includes more user time, and includes more parts. The assembly lift fixture 310 may be mounted to the hoist permanently instead of the regular mount on the EYE module. One assembly lift fixture 310 may be enough for any number of EYE used in the tool. Lifting may be accomplished via a protrusion of the EYE base plate and locking of the assembly lift fixture 310 to the protrusion may be via a quick clamp component (e.g., pin structure 340). This reduces cost of EYE lifting fixtures and may simplify design. As numbers of EYEs increase in a tool, conventionally the number of lifting fixtures also increases with increase in cost per fixture. With the assembly lift fixture 310, the cost of fixture for any number of EYEs would remain much lower than conventional systems.

The assembly lift fixture 310 may match the center of gravity position of the EYE module with the position of the assembly lift fixture 310 (e.g., by adjusting faster 350A in upper opening 334) in case there is any mismatch in the position of center of gravity. A lanyard 360 (e.g., lanyard cable) may attach the body component 330 (e.g., lifting fixture block) to the pin 344 (e.g., lifting pin) to prevent the pin from falling off the assembly lift fixture 310 during installation and maintenance activities.

The assembly lift fixture 310 may follow the SEMI S2 standard for lifting fixture. Per SEMI S2 item 18.6.1.1, the assembly lift fixture 310 may have a minimum of five times safety factory while lifting.

Each EYE may be a digital lithography imaging unit. Each EYE may include a diode laser illumination, a DMD array, and a reduction lens and is to expose patterns onto substrates. The assembly lift fixture 310 may be an EYE lifting device that is used to lift the EYE during installation and service.

The upper opening 334 may be a square opening to adjust the center of gravity of the EYE module. The lanyard 360 may be a lanyard cable that causes the pin 344 (e.g., lifting pin) to stay attached to the assembly lift fixture 310.

In some embodiments, a method includes one or more of the following operations (e.g., in the order shown or in different orders):
securing a first distal end 362 of a lanyard 360 to a body component 330 of an assembly lift fixture 310;
securing a second distal end 364 of the lanyard 360 to a pin 344 of a pin structure 340 of the assembly lift fixture 310;
inserting a fastener 350A into a cylindrical neck portion 324 of a hoist connector 320 of the assembly lift fixture 310 by passing the fastener 350 through an upper opening 334 of an upper flange 332 of the body component 330;
inserting fastener 350B into a bottom portion 336 of the body component 330;
securing fastener 350C to the bottom portion 336 of the body component 330 to secure the fastener 350B in the bottom portion 336 (e.g., prevent the fastener 350B from falling out of the bottom portion 336);
securing a disc-shaped upper portion 322 of hoist connector 320 to a hoist;
inserting a protrusion of an assembly in a recess 338 formed by sidewalls 370A-D of the bottom portion 336 of the body component 330;
passing a pin structure 340 (e.g., sleeve 342 secured around a pin 344 via a friction fit) through the bottom portion 336 (e.g., sidewall 370A and sidewall 370B) and the protrusion of the assembly (e.g., until one or more spring-loaded components 346 of pin 344 protrude from the pin 344 on the side of the sidewall 370B opposite the recess 338);
adjusting the position of the fastener 350A to a location within the upper opening 334 where a center of gravity of the assembly lift fixture 310 and assembly is at a predetermined location and securing the fastener 350A in the location within the upper opening 334;
causing the hoist to move (e.g., in the x-direction, the y-direction, and/or the z-direction) the assembly lift fixture 310 to move the assembly (e.g., to perform an installation, removal, maintenance, etc. of the assembly).

In some embodiments, one or more of operations of the method are performed by a controller (e.g., a processing device, via automation, etc.). In some embodiments, one or more of operations of the method are performed manually. Although shown in a particular sequence or order, unless otherwise specified, the order of the operations can be modified. Thus, the illustrated embodiments should be understood only as examples, and the illustrated operations can be performed in a different order, and some operations can be performed in parallel. Additionally, one or more operations and/or components can be omitted in various embodiments. Thus, not all operations and/or components are required in every embodiment.

The terms “first,” “second,” “third,” “fourth,” etc. as used herein are meant as labels to distinguish among different elements and do not have an ordinal meaning according to their numerical designation.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

The terms “over,” “under,” “between,” “disposed on,” “support,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations are performed in an inverse order so that certain operations are performed, at least in part, concurrently with other operations. In another embodiment, instructions or sub-operations of distinct operations are in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An assembly lift fixture comprising:
a body component comprising:
an upper flange forming an upper opening; and
a bottom portion forming a recess configured to receive a protrusion of an assembly;
a hoist connector secured to the upper flange via a first fastener partially passing through the upper opening; and
a pin structure configured to pass through the bottom portion of the body component and the protrusion of the assembly to secure the assembly to the assembly lift fixture.

2. The assembly lift fixture of claim 1, wherein:
the pin structure comprises a sleeve and a pin;
the sleeve is secured around the pin via friction fit; and
the sleeve and the pin pass through the protrusion of the assembly.

3. The assembly lift fixture of claim 2, wherein a distal portion of the pin comprises a spring-loaded component configured to protrude from the pin responsive to the pin passing through the bottom portion of the body component.

4. The assembly lift fixture of claim 1, wherein the hoist connector comprises a disc-shaped upper portion and a cylindrical neck portion.

5. The assembly lift fixture of claim 1 further comprising a lanyard comprising:
a first distal end configured to secure to the body component; and
a second distal end configured to secure to the pin structure.

6. The assembly lift fixture of claim 1 further comprising a second fastener configured to rotatably interface with the bottom portion to adjust size of the recess formed by the bottom portion.

7. The assembly lift fixture of claim 6 further comprising a third fastener configured to secure the second fastener in the bottom portion.

8. The assembly lift fixture of claim 1, wherein the upper opening is rectangular, wherein the first fastener is to adjustably secure to the hoist connector through the upper opening to adjust center of gravity of the assembly lift fixture securing the assembly.

9. An assembly lift fixture comprising:
a hoist connector comprising:
a disc-shaped upper portion configured to enter a disc-shaped chamber formed by a hoist; and
a cylindrical neck portion configured to pass through a slot formed by the hoist; and
a body component comprising:
an upper portion coupled to the hoist connector; and
a bottom portion configured to removably connect to an assembly, wherein the hoist is to move the assembly responsive to the hoist connector being coupled to the hoist and the bottom portion of the body component removably connecting to the assembly.

10. The assembly lift fixture of claim 9, wherein the upper portion of the body component is a flange forming an opening, wherein the flange is coupled to the hoist connector via a fastener passing through the opening and connected to the cylindrical neck portion.

11. The assembly lift fixture of claim 9, wherein the bottom portion forms a recess configured to receive a protrusion of the assembly.

12. The assembly lift fixture of claim 11 further comprising:
an adjustment fastener configured to rotatably interface with the bottom portion to adjust size of the recess formed by the bottom portion; and
a securing fastener configured to secure the adjustment fastener in the bottom portion.

13. The assembly lift fixture of claim 11 further comprising a pin structure configured to pass through the bottom portion of the body component and the protrusion of the assembly to secure the assembly to the assembly lift fixture.

14. The assembly lift fixture of claim 13, wherein:
the pin structure comprises a sleeve and a pin;
the sleeve is secured around the pin via friction fit; and
the sleeve and the pin pass through the protrusion of the assembly.

15. The assembly lift fixture of claim 13, wherein a distal portion of the pin structure comprises a spring-loaded component configured to protrude from the pin structure responsive to the pin structure passing through the bottom portion of the body component.

16. The assembly lift fixture of claim 13 further comprising a lanyard comprising:
a first distal end configured to secure to the body component; and
a second distal end configured to secure to the pin structure.

17. An assembly lift fixture comprising:
a hoist connector portion configured to couple to a hoist;
a bottom portion forming a recess configured to receive a protrusion of an assembly;
a sleeve configured to insert into a first sidewall of the bottom portion and pass through the protrusion of the assembly; and
a pin configured to pass through the first sidewall of the bottom portion, the sleeve, and a second sidewall of the bottom portion to secure the sleeve to the bottom portion.

18. The assembly lift fixture of claim 17 further comprising a lanyard comprising a first distal end secured to a surface of the assembly lift fixture and a second distal end secured to the pin.

19. The assembly lift fixture of claim 17, wherein the pin comprises one or more spring-loaded components configured to protrude from the pin responsive to the pin passing through the second sidewall of the bottom portion.

20. The assembly lift fixture of claim 17 further comprising:
an adjustment fastener configured to rotatably interface with the bottom portion to adjust size of the recess formed by the bottom portion; and
a securing fastener configured to secure the adjustment fastener in the bottom portion.
